(19) United States
(12) Patent Application Publication
(10) Pub. No.: US 2022/0292258 A1
(43) Pub. Date: Sep. 15, 2022

(54) DOCUMENT ENTITY EXTRACTION USING DOCUMENT REGION DETECTION

(71) Applicant: IRON MOUNTAIN INCORPORATED, Boston, MA (US)

(72) Inventors: Zhihong Zeng, Acton, MA (US); Harvarinder Singh, Toronto (CA); Rajesh Chandrasekhar, Franklin, TN (US); Ankit Chouksey, Bhopal (IN); Sandeep Kumar, Rohtas (IN); Anwar Chaudhry, Mississauga (CA)

(73) Assignee: IRON MOUNTAIN INCORPORATED, Boston, MA (US)

(21) Appl. No.: 17/694,301

(22) Filed: Mar. 14, 2022

Related U.S. Application Data
(60) Provisional application No. 63/160,403, filed on Mar. 12, 2021.

(51) Int. Cl. G06F 40/279; G06V 30/416; G06F 40/40; G06V 30/413

(52) U.S. Cl. CPC G06F 40/279; G06V 30/416; G06F 40/40; G06V 30/413

(57) ABSTRACT

In some embodiments, techniques for document entity extraction are provided. For example, a process may involve processing document images to detect a plurality of regions of interest that includes text objects and non-text objects; for each of the plurality of regions of interest, producing a corresponding text string; and processing the text strings to identify entities. Processing the document images may involve applying a text object detection model to the document images to detect the text objects; and applying at least one non-text object detection model to the document images to detect the non-text objects. Prior to processing the document images, at least two object detection models among the text object detection model and the at least one non-text object detection model were generated by fine-tuning respective instances of a pre-trained object detection model.

### TECHNICAL FIELD

The field of the present disclosure relates to document processing. More specifically, the present disclosure relates to techniques for detecting regions in unstructured documents and extracting entities from the regions.

### BACKGROUND

An unstructured document may contain content that lacks sufficient structure to be easily indexed. Entity extraction from unstructured documents is complicated by such lack of structure.

### SUMMARY

Certain embodiments involve document entity extraction using multiple instances of a pre-trained object detection model that have been separately fine-tuned to detect different respective classes of regions of interest. For example, a method for entity extraction includes processing document images to detect a plurality of regions of interest that includes text objects and non-text objects. The method also includes producing, based on a corresponding region of interest among the plurality of regions of interest, each of a plurality of text strings; and processing the text strings to identify a plurality of entities, wherein each of the plurality of entities is associated with a corresponding region of interest among the plurality of regions of interest. In this method, processing the document images involves applying a text object detection model to the document images to detect the text objects; and applying at least one non-text object detection model to the document images to detect the non-text objects. Prior to processing the document images, at least two of the object detection models among the text object detection model and the at least one non-text object detection model were generated by fine-tuning respective instances of a pre-trained object detection model.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 shows a block diagram of an entity extraction system according to certain aspects of the present disclosure.

FIG. 2 shows a portion of a document image that includes examples of text objects, according to certain aspects of the present disclosure.

FIGS. 3A and 3B show portions of document images that include examples of signature objects, according to certain aspects of the present disclosure.

FIG. 4 shows a portion of a document image that includes an example of a checkbox object, according to certain aspects of the present disclosure.

FIG. 5 shows a block diagram of another implementation of the entity extraction system, according to certain aspects of the present disclosure.

FIG. 6A shows examples of neighbor regions for signature objects, according to certain aspects of the present disclosure.

FIG. 6B shows an example of a neighbor region for a checkbox object, according to certain aspects of the present disclosure.

FIG. 7 shows a flowchart of a process of entity extraction, according to certain aspects of the present disclosure.

FIG. 8 shows a block diagram of a model training system, according to certain aspects of the present disclosure.

FIG. 9 shows a block diagram of another implementation of the model training system, according to certain aspects of the present disclosure.

FIG. 10 shows an example of a portion of a labeled document image in which five text objects are labeled, according to certain aspects of the present disclosure.

FIG. 11 shows an example of a portion of a labeled document image in which four signature objects are labeled, according to certain aspects of the present disclosure.

FIGS. 12A-12C show examples of portions of labeled document images in which checkbox objects are labeled, according to certain aspects of the present disclosure.

FIG. 13 shows a block diagram of a further implementation of the model training system, according to certain aspects of the present disclosure.

FIG. 14 shows a block diagram of an example computing device, according to certain aspects of the present disclosure.

### DETAILED DESCRIPTION

The subject matter of embodiments of the present disclosure is described here with specificity to meet statutory requirements, but this description is not necessarily intended to limit the scope of the claims. The claimed subject matter may be implemented in other ways, may include different elements or steps, and may be used in conjunction with other existing or future technologies. This description should not be interpreted as implying any particular order or arrangement among or between various acts or elements except when the order of individual acts or arrangement of elements is explicitly described.

Entity extraction from unstructured digital data, such as unstructured documents (e.g., images obtained by scanning or otherwise digitizing the pages of documents), may play an important role in a document processing workflow. Traditional methods for entity extraction assume that a representation of the unstructured text as produced by an optical character recognition (OCR) operation includes enough of the native structural context of the document to represent entity patterns. This assumption may be invalid, however, when the document includes tables or other multiple blocks, or when the document includes a non-text pattern, such as a biometric signature. Additionally, searching the whole document for the entities, particularly when a large set of documents are being searched, is not computationally efficient.

Certain aspects and examples of the disclosure relate to techniques for extracting entities from unstructured documents (e.g., document images). A computing platform may access one or more unstructured documents and perform processing operations on the documents. In some examples, the processing can include text region detection, signature detection, and checkbox detection on the unstructured document. The processing can also include optical character recognition on the detected regions of the unstructured document to generate a structured text of interest representation. Natural language processing may be performed on the structured text of interest representation to extract desired entities from the unstructured document.

Upon processing the unstructured documents to generate the structured text of interest representation, the computing platform may perform natural language processing, such as key-value detection, bag-of-words modeling, deep neural network (DNN) modeling, or question and answer operations, on content of the unstructured document using the structured text of interest representation. For example, the structured text of interest representation of the unstructured document may provide context to the text content within the unstructured document. In this manner, information of interest from the unstructured document may be extracted.

By utilizing the techniques presented herein, data can be efficiently and contextually extracted from unstructured documents (e.g., document images). Specifically, by integrating text recognition with box detection, a set of structured text representing the unstructured document can be generated.

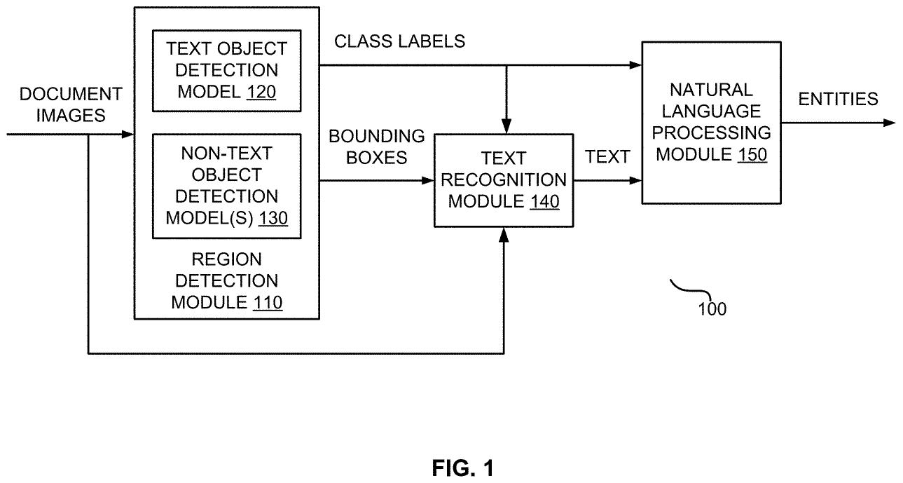

FIG. 1 shows a block diagram of an entity extraction system 100, according to certain aspects of the present disclosure. As shown in FIG. 1, the entity extraction system 100 includes a region detection module 110 that is configured to receive document images and process them to detect regions of interest (e.g., text objects and non-text objects) within the document images. System 100 also includes a text recognition module 140 that is configured to produce, for each of the regions of interest, a corresponding text string. The text recognition module 140 may be configured, for example, to generate a structured text of interest representation from an unstructured document, such as a scanned image of a document. System 100 also includes a natural language processing (NLP) module 150 that is configured to receive the text strings (e.g., to receive the structured text of interest representation) and to process the text strings to identify entities.

The system 100 may include a conversion module (not shown) that is configured to convert digital documents in a document file format (e.g., PDF) into document images in an image file format (e.g., TIFF). For example, the conversion module may be configured to convert each page of a digital document into a corresponding page image. Document images that have been obtained by scanning or otherwise digitizing the pages of documents may already be in an image file format.

The system 100 may include a pre-processing module (not shown) that is configured to pre-process document images to produce the plurality of document images for input to the system 100. Pre-processing of the image files may include, for example, any of the following operations: de-noising (e.g., Gaussian smoothing), affine transformation (e.g., de-skewing, translation, rotation, and/or scaling), perspective transformation (e.g., warping), normalization (e.g., mean image subtraction), histogram equalization. Pre-processing may include, for example, scaling the document images to a uniform size. In some cases, the object detection models of the region detection module 110 may be configured to accept input images of a particular size (e.g., 640 pixels wide×480 pixels high, 850 pixels wide×1100 pixels high, 1275 pixels wide×1650 pixels high, etc.).

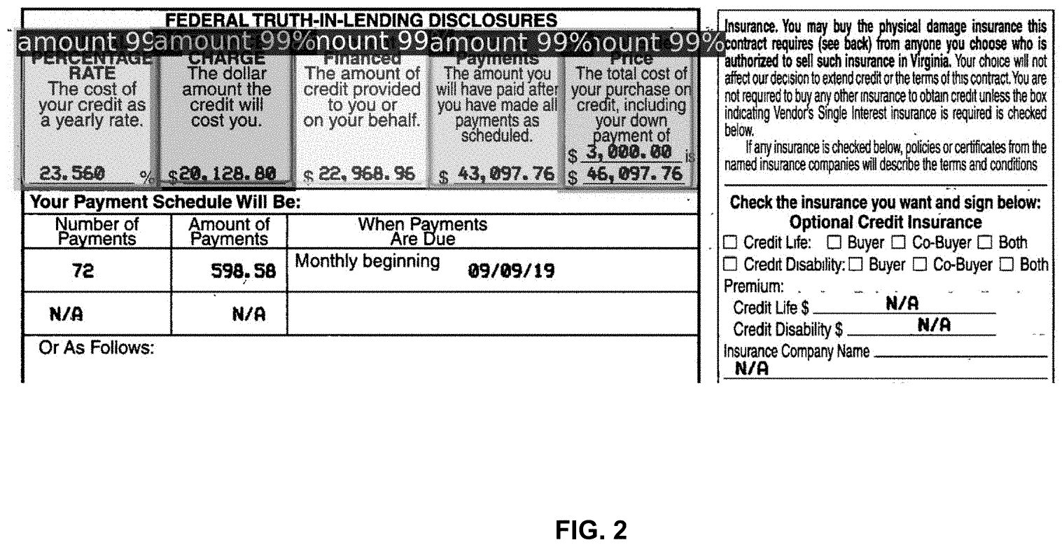

The region detection module 110 is configured to process a plurality of document images to detect a plurality of regions of interest that includes a plurality of text objects and a plurality of non-text objects. Each of the plurality of regions of interest is a region of a corresponding document image among the plurality of document images. As used herein, the term “text object” refers to a region of a document image whose semantic content is indicated by text characters (e.g., letters or numbers) within the region. FIG. 2 shows five examples of text objects (indicated by the shaded bounding boxes).

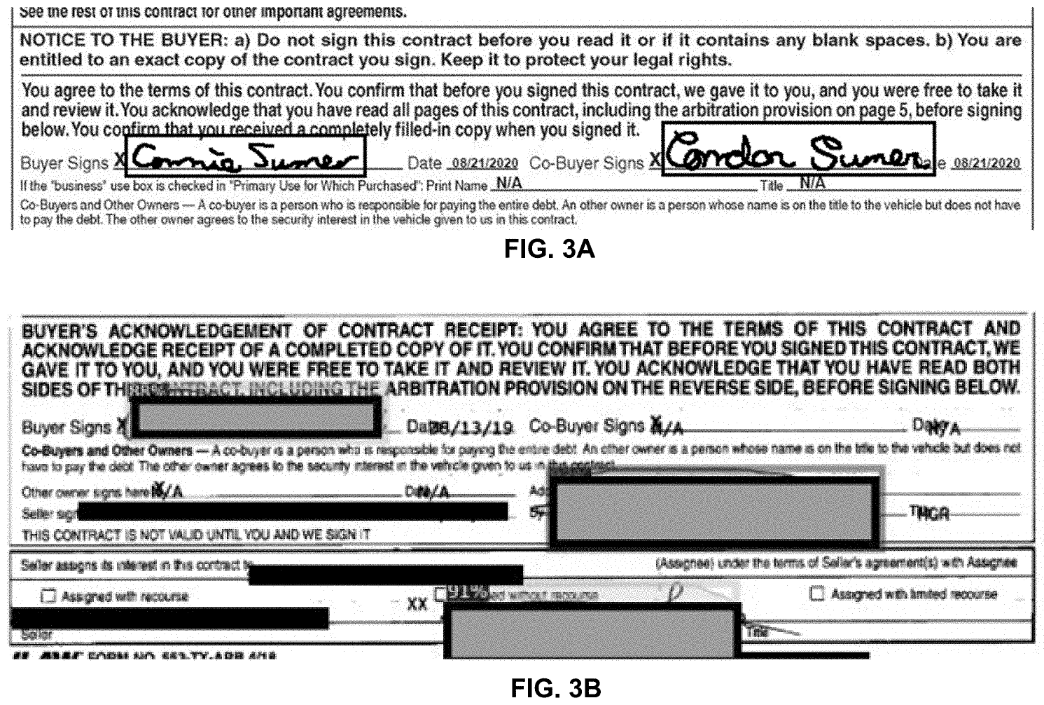

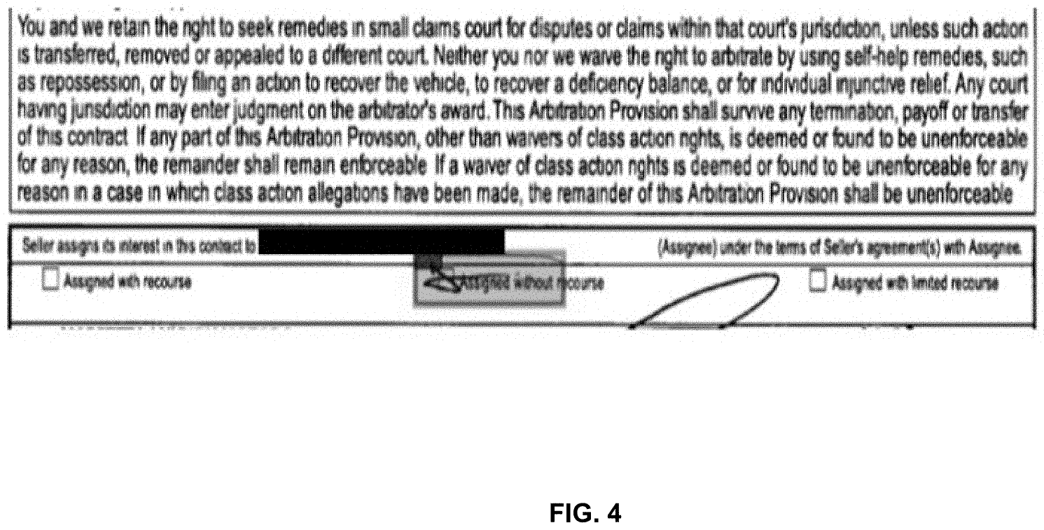

As used herein, the term “non-text object” refers to a region of a document image having semantic content that is indicated at least in part by non-printed (e.g., handwritten) markings or non-text characters (e.g., boxes) within the region. FIGS. 3A, 3B, and 4 show examples of non-text objects (indicated by corresponding bounding boxes). Specifically, FIGS. 3A and 3B (redacted) show several examples of a signature object (an object that includes a signature, such as a biometric (e.g., handwritten) signature), and FIG. 4 shows an example of a checkbox object (an object that includes a marked (e.g., checked) checkbox).

For each document image of the plurality of document images, the region detection module 110 may detect zero or more text objects and zero or more non-text objects. The plurality of document images may include, for example, documents for which the region detection module 110 detects at least one text object and at least one non-text object. Additionally or alternatively, the plurality of document images may include documents for which the region detection module 110 detects one or more text objects and no non-text objects and/or documents for which the region detection module 110 detects no text objects and one or more non-text objects. The plurality of document images may also include documents for which the region detection module 110 detects no text objects or non-text objects.

As shown in FIG. 1, the region detection module 110 is configured to apply a text object detection model 120 and at least one non-text object detection model 130 to the plurality of document images. The text object detection model 120 is configured to detect the plurality of text objects, and the at least one non-text object detection model 130 is(are) configured to detect the plurality of non-text objects. Two or more (and possibly all) of the object detection models 120 and 130 are generated (e.g., by a fine-tuning module 340 as described below) by fine-tuning respective instances of a pre-trained object detection model (e.g., a model 310 as described below).

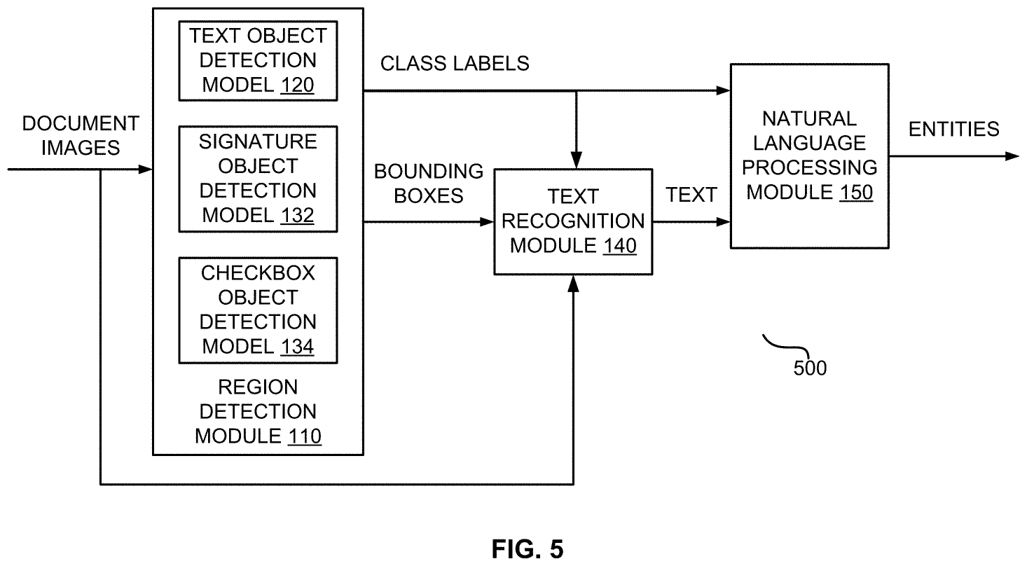

The region detection module 110 may be configured to apply the fine-tuned text object detection model 120 to the plurality of document images to detect the plurality of text objects and to apply the fine-tuned non-text object detection model(s) 130 to the plurality of document images to identify the plurality of non-text objects. FIG. 5 shows a block diagram of an implementation 500 of the entity extraction system 100 in which the region detection module 110 is configured to apply the text object detection model 120 to the plurality of document images to detect the plurality of text objects and to apply two fine-tuned non-text object detection models 130 to the plurality of document images to identify the plurality of non-text objects: a signature object detection model 132 to detect a plurality of signature objects and a checkbox object detection model 134 to detect a plurality of checkbox objects. As used herein, the term “checkbox object” refers to a region of interest that includes a marked (e.g., “checked-off”) checkbox.

The region detection module 110 is configured to indicate, for each of the detected regions of interest, a bounding box that indicates a boundary of the region of interest within the corresponding document image, and a class label that indicates a class of the region of interest. A bounding box may be indicated by information sufficient to identify the two-dimensional (2D) coordinates of the four corners of the bounding box within the corresponding document image. In one example, a bounding box is indicated by the 2D coordinates of one corner (e.g., the upper-left corner) together with the width and height of the bounding box (e.g., in pixels). In another example, a bounding box is indicated by the 2D coordinates of two opposite corners of the bounding box (e.g., the upper-left and lower-right corners).

The set of classes for text objects may include, for example, amount (e.g., as shown in FIG. 2), home address, etc. In an example, the text object detection model 120 may be trained to identify regions of interest that are associated with prices or rates. The set of classes for non-text objects may include, for example, signature for signature objects (e.g., as in FIG. 3B), checkbox for checkbox objects (e.g., as in FIG. 4), etc. In an example, the signature object detection model 132 may be trained to identify regions of interest that include biometric (e.g., handwritten) signatures, and the checkbox object detection model 134 may be trained to identify regions of interest that include marked (e.g., checked) checkboxes. The region detection module 110 may also be configured to indicate, for each of the detected regions of interest, a confidence of the detection prediction (as shown, for example, in FIG. 2 (‘99%’), FIG. 3B (‘88%’, ‘93%’, ‘91%’), and FIG. 4 (‘96%’)).

The text recognition module 140 is configured to produce, for each of the plurality of regions of interest, a corresponding text string (e.g., from an indicated portion of the corresponding document image). As used herein, the term “text string” refers to a string of text characters (possibly including one or more line breaks). As shown in FIG. 1, the text recognition module 140 may be configured to receive, for each of the regions of interest, a bounding box and a class label and to produce a text string from a portion of the corresponding document image that is indicated by the bounding box and the class label. In association with corresponding location information (e.g., the bounding box information of the corresponding regions of interest), the text strings produced by the text recognition module 140 represent structured texts of interest.

The region detection module 110 may identify one or more regions of interest (e.g., text objects) within a document image, and the text recognition module 102 may identify characters, such as letters and numbers, in the regions of interest of the document image. In other words, regions of interest of the document image may be converted by the text recognition module 140 into machine-encoded text representations of corresponding portions of the document image.

For each document image, the text recognition module 140 may provide a structured text of interest representation of the document image. The structured text of interest representation includes text strings produced by the text recognition module 140 from regions of interest within the document image, as detected by the region detection module 110. The structured text of interest representation also includes location information for each text string, such as the corresponding bounding box information of those regions of interest (and possibly the corresponding class labels) as indicated by the region detection module 110.

The text recognition module 140 may be configured to produce, for each of the regions of interest, a text string from an indicated portion of the corresponding document image. For the text regions detected by the region detection module 110, the indicated portion of the corresponding document image may be the portion bounded by the bounding box. For example, the text recognition module 140 may be configured to perform optical character recognition (OCR) on each of the detected text objects (e.g., as indicated by the corresponding bounding boxes) to produce the corresponding text string.

For the non-text regions detected by the region detection module 110 (e.g., signature objects, checkbox objects), the indicated portion of the corresponding document image may include a neighbor region of the portion that is bounded by the bounding box. For example, the text recognition module 140 may be configured to perform OCR on a neighbor region of each of the detected non-text objects to produce the corresponding text string.

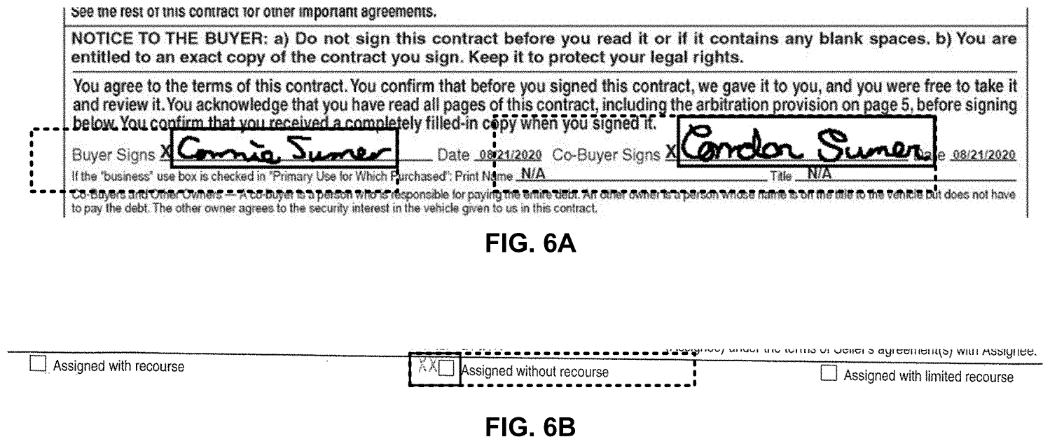

The neighbor region may extend to the left of, to the right of, above, and/or below the portion of the document image that is bounded by the bounding box. A dimension of the neighbor region may be based on a corresponding dimension of the non-text region (e.g., as indicated by the bounding box), and a shape of the neighbor region relative to the non-text region may be based on the class of the non-text region. As shown in FIG. 6A, for example, the neighbor region for a signature object may include an area to the left of the signature object and may also include an area below the signature object, and the sizes of these areas may be proportional to the size of the signature object. As shown in FIG. 6B, for example, the neighbor region for a checkbox object may include an area to the right of the checkbox region, and the size of this area may be proportional to the size of the checkbox object.

In some implementations of the text recognition module 140, the neighbor region includes the portion bounded by the bounding box. In other implementations of the text recognition module 140, the neighbor region does not include the portion bounded by the bounding box. In further implementations of the text recognition module 140, whether the neighbor region includes or does not include the portion bounded by the bounding box is based on the class of the non-text region (e.g., included for signature objects, not included for checkbox objects).

In some examples, a structured document provided to or otherwise accessed by the document entity extraction system 100 may already be in a machine-encoded state. Accordingly, the document entity extraction process may proceed without the optical character recognition operation of the text recognition module 140 on such a document. The text recognition module 140 may be also configured to use other text recognition operations on the document images in place of an optical character recognition operation. For example, the text recognition module 140 may be configured to use optical word recognition, intelligent character recognition, intelligent word recognition, or any other text recognition operations in place of the optical character recognition operation.

The natural language processing (NLP) module 150 is configured to process the plurality of text strings to identify a plurality of entities. For example, the NLP module 150 may be configured to perform natural language processing operations on a structured text of interest representation of an unstructured document (e.g., as generated by the text recognition module 140) to extract particular entities from the unstructured document, where the structured text of interest representation may include, for each of one or more detected regions of interest, the corresponding text string and its location within the unstructured document (e.g., document image). For each of the plurality of text strings, the NLP module 150 may be configured to perform any one or more of the following entity extraction operations on the text string to identify an entity associated with the corresponding region of interest:

1) search for one or more regular expression (regex) patterns (e.g., to find a corresponding substring in the text string);

2) perform key-value detection (to extract a key-value pair, for example, or to find a corresponding value for a given key (e.g., price, payment, etc.));

3) apply a bag-of-words model;

4) apply a DNN model (e.g., an autoencoding-based model, such as BERT (Bi-directional Encoder Representation from Transformers); an autoregressive model, such as XLnet; etc.);

5) apply a question answering model (e.g., to extract an answer to a given question).

For each of at least some of the text strings, the NLP module 150 may be configured to find one or more specified “anchor words” within the text string. Such anchor words may be used to configure an entity extraction operation as noted above (e.g., regex searching, key-value detection, question answering) and/or to filter the results of such an operation (e.g., entity extraction using a bag-of-words or DNN model) to identify relevant entities.

The anchor words may be specified in a dictionary, and the NLP module 150 may be configured to use different dictionaries for text strings that correspond to regions of interest of different classes. For example, the NLP module 150 may be configured to select a dictionary from among a plurality of dictionaries, based on the class of the detected region of interest, and to identify an entity in the corresponding text string based on the dictionary.

In one such example, the NLP module 150 is configured to find one or more anchor words only within text strings that correspond to non-text objects. For non-text objects of a signature object class, for example, the NLP module 150 may be configured to select a dictionary that includes anchor words such as, e.g., ‘buyer’, ‘seller’, ‘co-buyer’, ‘assignor’, ‘assignee’, ‘signs’, ‘signature’, ‘sign’, ‘sign here’. For non-text objects of a checkbox object class, the NLP module 150 may be configured to select a dictionary that includes anchor words such as, e.g., ‘assigned’, ‘recourse’, ‘limited’, ‘with’, ‘without’, ‘single’, ‘joint’, ‘none’. In another such example, the NLP module 150 is also configured to find one or more anchor words within text strings that correspond to text objects.

The output of the NLP module 150 may be one or more entities from the corresponding unstructured document. For example, the NLP module 150 may be configured to identify and extract a buyer or seller signature (e.g., the signature object that includes the actual biometric signature of the identified party) from a sales agreement, a price number from a sales agreement, particular details identified by checkboxes, or any other entities from the unstructured document. Further examples of entities that may be extracted from text objects include a payment, a price, an annual percentage rate (APR), etc. Further examples of entities that may be extracted from signature objects or their neighbor regions include an identifier of the party who has signed (e.g., buyer, seller, co-buyer, assignee, assignor, etc.), a signature of a buyer, a signature of a seller, a signature of a co-buyer, etc. Further examples of entities that may be extracted from checkbox objects or their neighbor regions of checkbox objects include a transaction type (e.g., with recourse, without recourse, or with limited recourse), a broker status (e.g., buyer's agent, seller's agent, transaction-broker), a marked checkbox, etc. Applications of such entity extraction may include, for example, verifying that a contract is signed by both the buyer and the seller; identifying whether an assignment has been made without recourse; etc.

In an example, the processes of the document entity extraction system 100 may all be performed as microservices of a remote or cloud computing system, or may be implemented in one or more containerized applications on a distributed system (e.g., using a container orchestrator, such as Kubernetes). Alternatively, the processes of the document entity extraction system 100 may be performed locally as modules running on a computing platform associated with the document extraction system 100. In either case, such a system or platform may include multiple processing devices (e.g., multiple computing devices) that collectively perform the process. In some examples, the entity extraction system 100 may be accessed through a detection application programming interface (API). The detection API may be deployed as a gateway to a microservice or a Kubernetes system on which the processes of the document entity extraction system 100 may be performed. The microservice or Kubernetes system may provide computing power to serve large scale document processing operations.

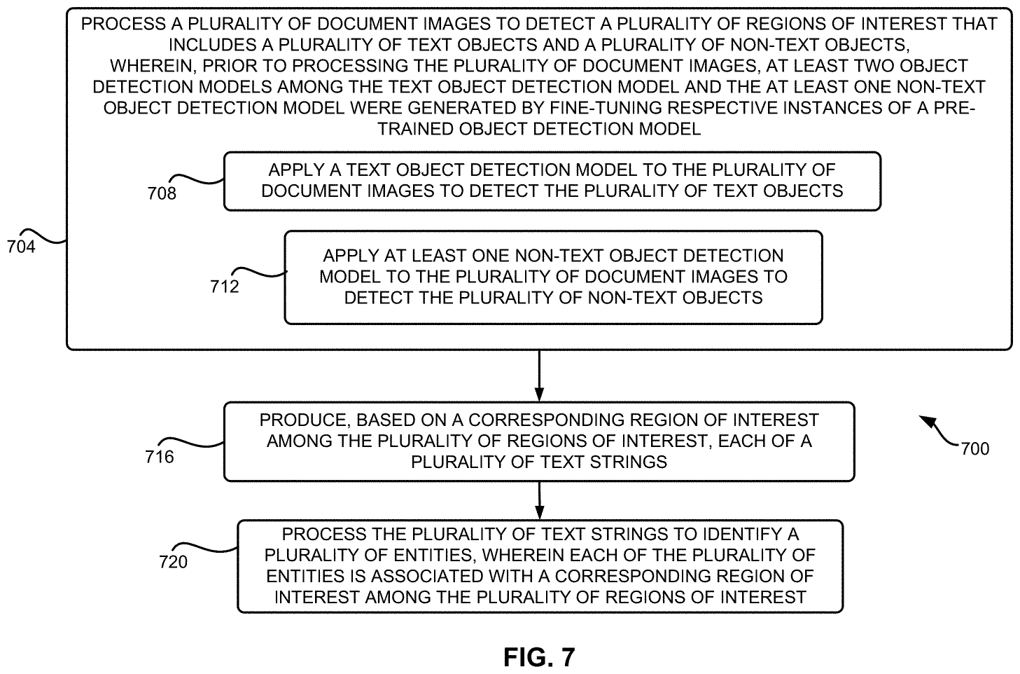

FIG. 7 depicts an example of a process 700 of entity extraction, according to certain embodiments of the present disclosure. One or more processing devices (e.g., one or more computing devices) implement operations depicted in FIG. 7 by executing suitable program code. For example, process 700 may be executed by an instance of the entity extraction system 100. For illustrative purposes, the process 700 is described with reference to certain examples depicted in the figures. Other implementations, however, are possible.

At block 704, the entity extraction process involves processing (e.g., by a region detection module as described herein) a plurality of document images to detect a plurality of regions of interest that includes a plurality of text objects and a plurality of non-text objects. In an example, the document images are stored in a manner that enables access to the document images by a system executing the process (e.g., the entity extraction system 100). For example, the document images may be stored locally with the entity extraction system, or the entity extraction system may access the document images from a remote storage system (e.g., via a detection API).

Block 704 includes sub-blocks 708 and 712. At block 708, the entity extraction process involves applying a text object detection model to the plurality of document images to detect the plurality of text objects. At block 712, the entity extraction process involves applying at least one non-text object detection model to the plurality of document images to detect the plurality of non-text objects. Prior to the execution of block 704 (e.g., prior to processing the plurality of document images), at least two of the object detection models among the text object detection model and the at least one non-text object detection model have been generated by fine-tuning respective instances of a pre-trained object detection model.

At block 716, the entity extraction process involves producing (e.g., by a text recognition module as described herein), based on a corresponding region of interest among the plurality of regions of interest, each of a plurality of text strings. For example, block 716 may include generating, for each of at least some of the plurality of document images, a corresponding structured text of interest representation that includes, for each of one or more text strings, the text string and a location associated with the text string within the document image.

At block 720, the entity extraction process involves processing (e.g., by a natural language processing module as described herein) the plurality of text strings to identify a plurality of entities, wherein each of the plurality of entities is associated with a corresponding region of interest among the plurality of regions of interest. For example, block 720 may include, for each of the plurality of document images, performing one or more NLP operations on a structured text representation of the document image (e.g., as generated by text recognition module 140) to identify one or more entities of the document image.

One or more pre-trained deep neural networks (e.g., one or more deep convolutional neural networks (CNNs)) may be fine-tuned, in a supervised training process using labeled data, to generate the text object detection model 120 and the non-text object detection model(s) 130 (e.g., signature and checkbox object detection models). In one such example, a first pre-trained deep CNN is fine-tuned, using a first set of labeled data, to generate the text object detection model 120, and respective instances of a second pre-trained deep CNN are fine-tuned, using corresponding sets of labeled data, to generate two or more non-text object detection models (e.g., signature object detection model 132 and checkbox object detection model 134). In another such example, respective instances of a pre-trained deep CNN are fine-tuned, using corresponding sets of labeled data, to generate the text object detection model 120 and the non-text object detection model(s) 130. In each case, the fine-tuning may be performed to generate the corresponding text or non-text object detection model according to a target accuracy (e.g., mean average precision), such as, for example, an average detection prediction accuracy of at least 80%. Any one or more of the object detection models 120, 130, 132, 134 may also be trained to other more-stringent or less-stringent target accuracies. Generally, the larger the corpus of labeled data used to train a model is, the more accurate the resulting model may be. For example, the larger the corpus of labeled data used to fine-tune the corresponding instance of a pre-trained deep CNN is, the more accurate the resulting object detection model may be.

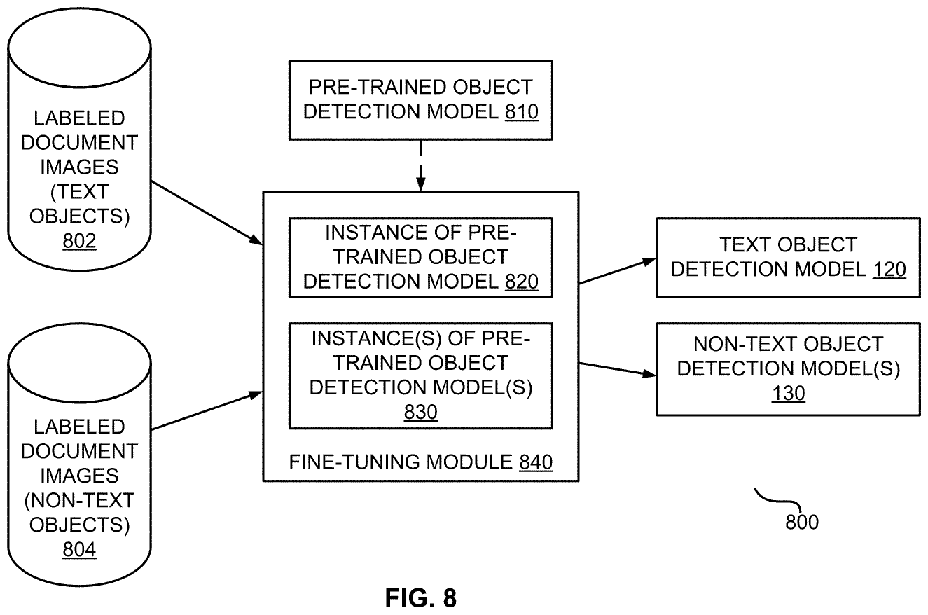

FIG. 8 is a block diagram of a model training system 800, according to certain aspects of the present disclosure. In this example, a fine-tuning module 840 is configured to generate the text object detection model 120 by fine-tuning a first instance 820 of a pre-trained object detection model 810, using a set 802 of labeled document images in which text objects are labeled, and to generate the at least one non-text object detection model 130 by fine-tuning at least a second instance 830 of the pre-trained object detection model 810, using a set 804 of labeled document images in which non-text objects are labeled. In another example, the at least one non-text object detection model 130 includes a first non-text object detection model (e.g., a signature object detection model 132 as described herein) and a second non-text object detection model (e.g., a checkbox object detection model 134 as described herein), and the fine-tuning module 840 is configured to generate these object detection models by fine-tuning respective instances of the pre-trained object detection model 810.

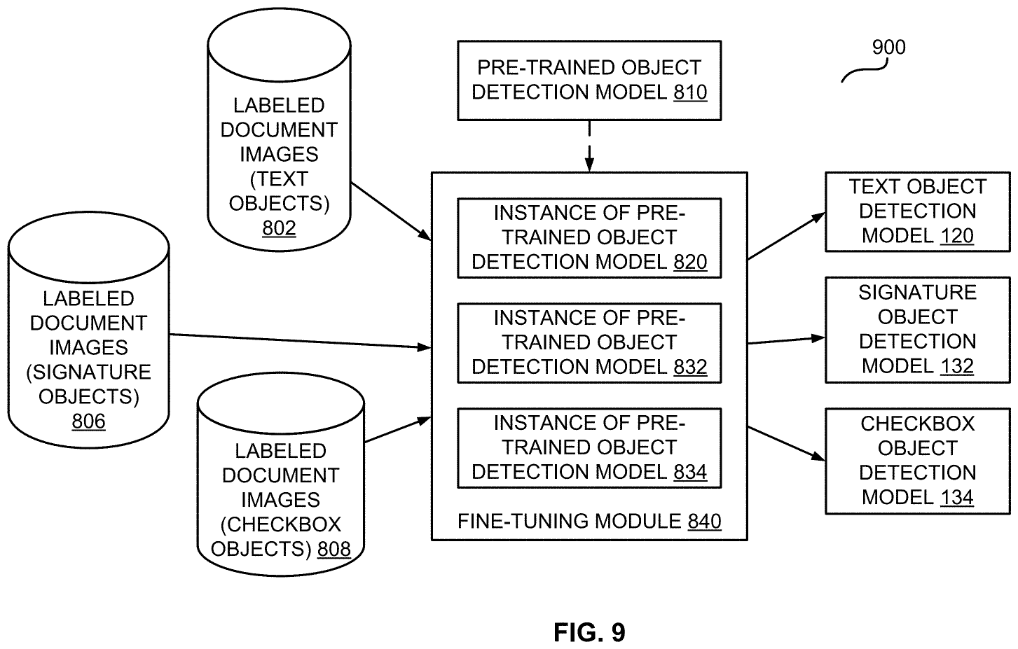

FIG. 9 shows a further example of an implementation 900 of model training system 800 in which the fine-tuning module 840 is configured to generate each of the text object detection model 120, a first non-text object detection model (e.g., a signature object detection model 132), and a second non-text object detection model (e.g., a checkbox object detection model 134) by fine-tuning a respective instance 820, 832, 834 of the pre-trained object detection model 810, using a corresponding one of sets 802, 806, and 808 of labeled document images in which text objects, signature objects, and checkbox objects, respectively, are labeled. The model training system 800 (e.g., the fine-tuning module 840) may be implemented as a part of the document entity extraction system 100 or may be implemented separately.

The pre-trained object detection model 810 includes a pre-trained deep neural network (DNN), such as a deep convolutional neural network (CNN). In one example, the pre-trained object detection model 810 is based on a region proposal algorithm (e.g., a model based on an algorithm such as R-CNN, Fast R-CNN model, etc.) or includes a region proposal network (e.g., a model based on an algorithm such as Faster R-CNN, Mask R-CNN, etc.). In another example, the pre-trained object detection model 810 includes a feature pyramid network (e.g., an implementation of an EfficientDet model) or a model zoo (e.g., a model implemented using modules from the detectron2 platform (Facebook AI Research)) In another example, the pre-trained object detection model 810 includes a one-shot detector (e.g., a model according to any of versions 1-5 of YOLO (You Only Look Once), PP-YOLO, or Single Shot Detector (SSD), etc.).

The pre-trained object detection model 810 may be pre-trained on images from a dataset for object class recognition, such as a Pascal Visual Object Classes (VOC) dataset (available online Mar. 9, 2022 from host.robots.ox.ac.uk/pascal/VOC/) or the Common Objects in Context (COCO) dataset (available online Mar. 9, 2022 from cocodataset.org). Alternatively or additionally, the pre-trained object detection model 810 may be pre-trained on images from a document dataset, such as the Ryerson Vision Lab Complex Document Information Processing (RVL-CDIP) dataset (available online Mar. 9, 2022 from www.cs.cmu.edu/˜aharley/rvl-cdip/) or the ITT CDIP 1.0 (Illinois Institute of Technology Complex Document Information Processing Test Collection, version 1.0) dataset (available online Mar. 9, 2022 from ir.nist.gov/cdip/).

The fine-tuning module 840 may be configured to fine-tune the instances (e.g., 820, 830) of the pre-trained object detection model 810 by further training some or all of the parameters of each model instance in a supervised training process. For example, the fine-tuning module 840 may be configured to further train some or all of the parameters of each model instance using labels of one or more sets of labeled document images as ground truth.

The labeled document images may be manually labeled. For example, the labeled document images may be prepared (e.g., by one or more human labelers) by labeling each document image of a training set of document images (which may be drawn from a dataset as mentioned above) with one or more bounding boxes, each bounding box indicating a boundary of a corresponding region of interest within the document image. The label may include information sufficient to identify the two-dimensional (2D) coordinates of the four corners of the bounding box within the document image, such as the 2D coordinates of one corner (e.g., the upper-left corner) and the width and height of the bounding box (e.g., in pixels), or the 2D coordinates of two opposite corners of the bounding box (e.g., the upper-left and lower-right corners), etc.

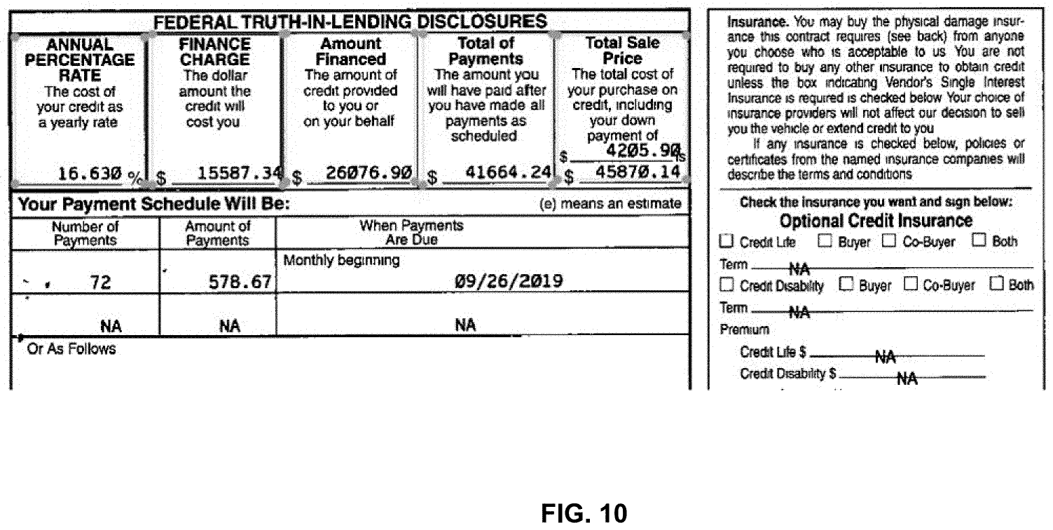

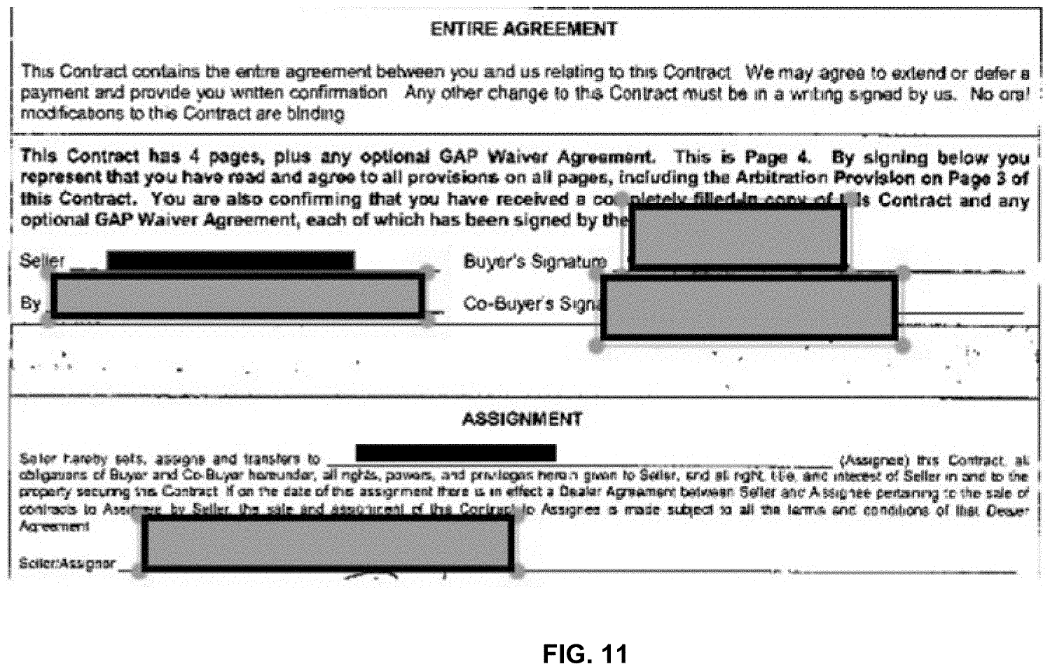

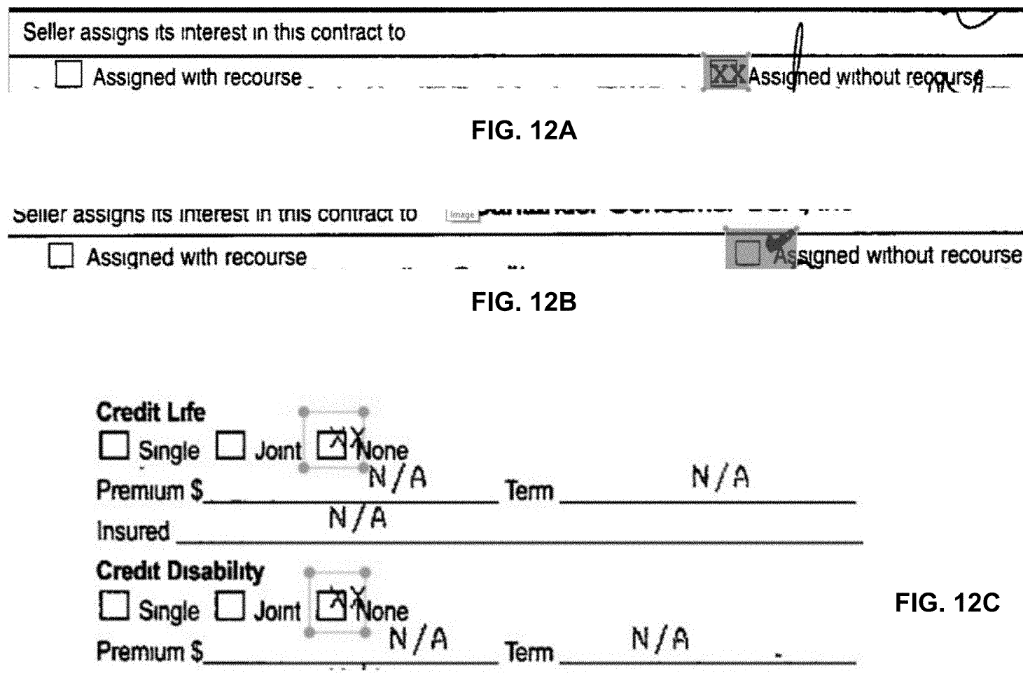

FIGS. 10, 11, and 12A-C show examples of portions of labeled document images as discussed above in which the bounding boxes of various text objects and non-text objects are shown. In these examples, each bounding box is outlined, and the four corners of each bounding box are indicated by dots. FIG. 10 shows an example in which five text regions are labeled, and FIG. 11 shows an example in which four signature regions are labeled. (Although personal identifying information has been redacted from FIG. 11, it will be understood that such information would be present in the labeled document images.) FIGS. 12A and 12B each show examples in which a checkbox region is labeled, and FIG. 12C shows an example in which two checkbox regions are labeled. As shown in the examples of FIGS. 12A-C, the check mark for a checkbox may be typed or handwritten and may be partially or even completely outside the checkbox.

In the example of FIG. 8, the fine-tuning module 840 is configured to fine-tune the first instance 820 of the pre-trained object detection model 810, using a set 802 of document images that are each labeled with the bounding box(es) of one or more text objects within the document image, to generate the fine-tuned text object detection model 120. In the example of FIG. 8, the fine-tuning module 840 is also configured to fine-tune the at least second instance 830 of the pre-trained object detection model 810, using a set 804 of document images that are each labeled with the bounding box(es) of one or more non-text objects within the document image, to generate the fine-tuned non-text object detection model(s) 130.

In the example of FIG. 9, the fine-tuning module 840 is configured to fine-tune the first instance 820 of the pre-trained object detection model 810, using a set 802 of document images that are each labeled with the bounding box(es) of one or more text objects within the document image, to generate the fine-tuned text object detection model 120. In the example of FIG. 9, the fine-tuning module 840 is also configured to fine-tune a second instance 832 of the pre-trained object detection model 810, using a set 806 of document images that are each labeled with the bounding box(es) of one or more signature objects within the document image, to generate the fine-tuned signature object detection model 132. In the example of FIG. 9, the fine-tuning module 840 is further configured to fine-tune a third instance 834 of the pre-trained object detection model 810, using a set 808 of document images that are each labeled with the bounding box(es) of one or more checkbox objects within the document image, to generate the fine-tuned checkbox object detection model 134.

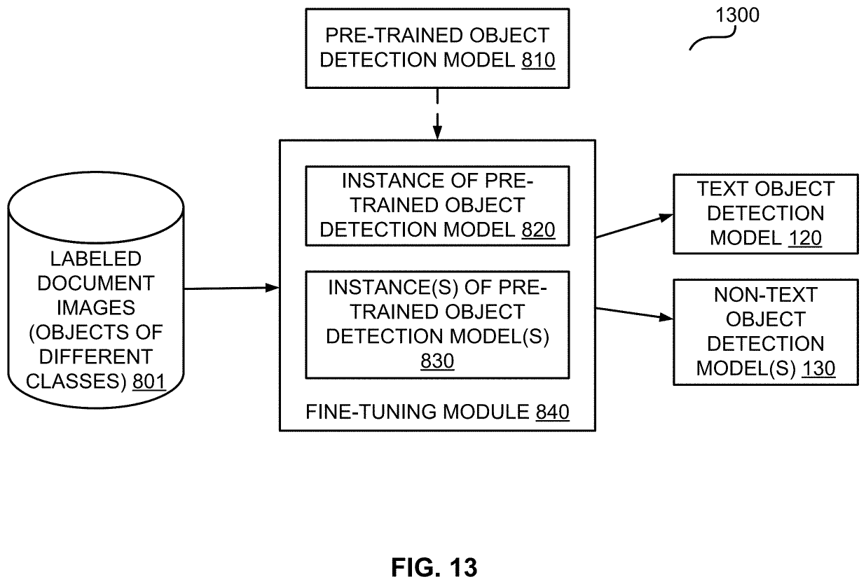

As noted above, a labeled document image may have more than one region of interest of a particular class. The label of each of the labeled document images (e.g., as manually labeled) may also indicate, for each region of interest that is indicated by a corresponding bounding box, a class name of the region of interest (e.g., home address, amount, signature, checkbox, etc.). In this case, the fine-tuning module 340 may be configured to fine-tune each instance of the pre-trained object detection model 810 using the labeled document images which have labels indicating the class(es) that the resulting fine-tuned object detection model is to detect. FIG. 13 shows an example of an implementation 1300 of model training system 800 in which a set 801 of labeled document images is provided. In this example, the labels of the labeled document images of the set 801 include labels indicating regions of interest of different classes, and the fine-tuning module 840 is configured to fine-tune each instance 820, 830 of the pre-trained object detection model 810 using labeled document images from the set 801 which have labels indicating the class(es) that the corresponding resulting object detection model 120, 130 is to detect.

A method of producing object detection models may include fine-tuning, based on a first plurality of labeled document images, a first instance of a pre-trained object detection model to generate a text object detection model; and fine-tuning, based on a second plurality of labeled document images, a second instance of a pre-trained object detection model to generate a non-text object detection model (e.g., as described above with reference to the fine-tuning module 840). In this method, each of the first plurality of labeled document images is labeled with at least one bounding box that indicates a boundary of a text object, and each of the second plurality of annotated document images is labeled with at least one bounding box that indicates a boundary of a non-text object. The method may further include training a deep CNN to generate the pre-trained object detection model. One or more processing devices (e.g., one or more computing devices) may implement the operations of such a method of producing object detection models by executing suitable program code. For example, such a method may be executed by an instance of the fine-tuning module 840. Other implementations, however, are possible.

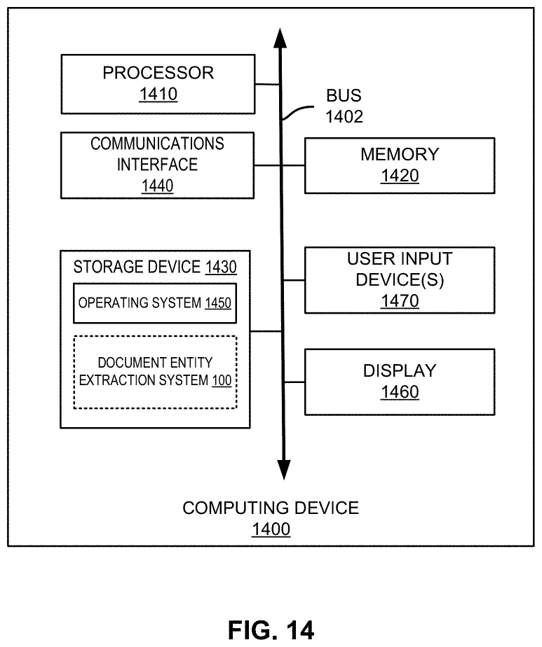

FIG. 14 shows an example computing device 1400 suitable for implementing aspects of the techniques and technologies presented herein. The example computing device 1400 includes a processor 1410 which is in communication with a memory 1420 and other components of the computing device 1400 using one or more communications buses 1402. The processor 1410 is configured to execute processor-executable instructions stored in the memory 1420 to perform secure data protection and recovery according to different examples, such as part or all of the example process 700 or other processes described above with respect to FIGS. 1-13. In an example, the memory 1420 is a non-transitory computer-readable medium that is capable of storing the processor-executable instructions. The computing device 1400, in this example, also includes one or more user input devices 1470, such as a keyboard, mouse, touchscreen, microphone, etc., to accept user input. The computing device 1400 also includes a display 1460 to provide visual output to a user. In other examples of a computing device (e.g., a device within a cloud computing system), such user interface devices may be absent.

The computing device 1400 can also include or be connected to one or more storage devices 1430 that provides non-volatile storage for the computing device 1400. The storage devices 1430 can store an operating system 1450 utilized to control the operation of the computing device 1400. The storage devices 1430 can also store other system or application programs and data utilized by the computing device 1400, such as modules implementing the functionalities provided by the entity extraction system 100 or any other functionalities described above with respect to FIGS. 1-13. The storage devices 1430 might also store other programs and data not specifically identified herein.

The computing device 1400 can include a communications interface 1440. In some examples, the communications interface 1440 may enable communications using one or more networks, including: a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically configured hardware, such as field-programmable gate arrays (FPGAs) specifically, to execute the various methods. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media (for example, computer-readable storage media) that may store instructions that, when executed by the processor, can cause the processor to perform the steps described herein as carried out, or assisted, by a processor. Examples of computer-readable media may include, but are not limited to, an electronic, optical, magnetic, or other storage device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code for carrying out one or more of the methods (or parts of methods) described herein.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C. For the purposes of the present document, the phrase “A is based on B” means “A is based on at least B”.

Different arrangements of the components depicted in the drawings or described above, as well as components and steps not shown or described are possible. Similarly, some features and sub-combinations are useful and may be employed without reference to other features and sub-combinations. Embodiments of the presently subject matter have been described for illustrative and not restrictive purposes, and alternative embodiments will become apparent to readers of this patent. Accordingly, the present disclosure is not limited to the embodiments described above or depicted in the drawings, and various embodiments and modifications may be made without departing from the scope of the claims below.

1. A computer-implemented method of entity extraction, the method comprising:
processing a plurality of document images to detect a plurality of regions of interest that includes a plurality of text objects and a plurality of non-text objects;
producing, based on a corresponding region of interest among the plurality of regions of interest, each of a plurality of text strings; and
processing the plurality of text strings to identify a plurality of entities, wherein each of the plurality of entities is associated with a corresponding region of interest among the plurality of regions of interest,
wherein processing the plurality of document images includes:
applying a text object detection model to the plurality of document images to detect the plurality of text objects; and
applying at least one non-text object detection model to the plurality of document images to detect the plurality of non-text objects, and
wherein, prior to processing the plurality of document images, at least two object detection models among the text object detection model and the at least one non-text object detection model were generated by fine-tuning respective instances of a pre-trained object detection model.

2. The computer-implemented method of claim 1, wherein:
the text object detection model was generated by fine-tuning a first instance of the pre-trained object detection model, and
the at least one non-text object detection model was generated by fine-tuning at least a second instance of the pre-trained object detection model.

3. The computer-implemented method of claim 1, wherein the at least one non-text object detection model includes a signature object detection model and a checkbox object detection model.

4. The computer-implemented method of claim 3, wherein:
the signature object detection model was generated by fine-tuning a first instance of the pre-trained object detection model, and
the checkbox object detection model was generated by fine-tuning a second instance of the pre-trained object detection model.

5. The computer-implemented method of claim 3, wherein:
the text object detection model was generated by fine-tuning a first instance of the pre-trained object detection model,
the signature object detection model was generated by fine-tuning a second instance of the pre-trained object detection model, and
the checkbox object detection model was generated by fine-tuning a third instance of the pre-trained object detection model.

6. The computer-implemented method of claim 1, wherein each of the plurality of regions of interest is a region of a corresponding document image among the plurality of document images, and
wherein processing the plurality of document images to detect the plurality of regions of interest includes indicating, for each of the plurality of regions of interest:
a bounding box that indicates a boundary of the region of interest within the corresponding document image, and
a class label that indicates a class of the region of interest, and wherein:
for at least some of the plurality of text objects, the class of the text object is a first class, and
for each of the plurality of non-text objects, the class of the non-text object is different than the first class.

7. The computer-implemented method of claim 1, wherein each of the plurality of regions of interest is a region of a corresponding document image among the plurality of document images, and
wherein, for each of the plurality of regions of interest, producing the corresponding text string is based on a class of the region of interest and on a bounding box that indicates a boundary of the region of interest within the corresponding document image, and
wherein:
for at least some of the plurality of text objects, the class of the text object is a first class, and
for each of the plurality of non-text objects, the class of the non-text object is different than the first class.

8. The computer-implemented method of claim 1, wherein:
each of the plurality of regions of interest is a region of a corresponding document image among the plurality of document images;
for each of the plurality of text objects, producing the corresponding text string includes obtaining the text string from the text object, and
for each of the plurality of non-text objects, producing the corresponding text string includes obtaining the text string from a neighbor region of the non-text object within the corresponding document image, wherein a shape of the neighbor region relative to the non-text object is based on a class of the non-text object.

9. The computer-implemented method of claim 8, wherein for each of the plurality of non-text objects, obtaining the corresponding text string comprises performing optical character recognition (OCR) on the neighbor region of the non-text object.

10. The computer-implemented method of claim 1, wherein processing the plurality of text strings includes, for each of the plurality of non-text objects:
selecting, based on a class of the non-text object, a dictionary from among a plurality of dictionaries; and
identifying, based on the corresponding text string and the dictionary, an entity associated with the non-text object.

11. An entity extraction system, the system comprising:
one or more processing devices; and
one or more non-transitory computer-readable media communicatively coupled to the one or more processing devices, wherein the one or more processing devices are configured to execute the program code stored in the non-transitory computer-readable media and thereby perform operations comprising:
processing a plurality of document images to detect a plurality of regions of interest that includes a plurality of text objects and a plurality of non-text objects;
producing, based on a corresponding region of interest among the plurality of regions of interest, each of a plurality of text strings; and
processing the plurality of text strings to identify a plurality of entities, wherein each of the plurality of entities is associated with a corresponding region of interest among the plurality of regions of interest,
wherein processing the plurality of document images includes:
applying a text object detection model to the plurality of document images to detect the plurality of text objects; and
applying at least one non-text object detection model to the plurality of document images to detect the plurality of non-text objects, and
wherein, prior to processing the plurality of document images, at least two object detection models among the text object detection model and the at least one non-text object detection model were generated by fine-tuning respective instances of a pre-trained object detection model.

12. The entity extraction system of claim 11, wherein:
the text object detection model was generated by fine-tuning a first instance of the pre-trained object detection model, and
the at least one non-text object detection model was generated by fine-tuning at least a second instance of the pre-trained object detection model.

13. The entity extraction system of claim 11, wherein the at least one non-text object detection model includes a signature object detection model and a checkbox object detection model.

14. The entity extraction system of claim 13, wherein:
the signature object detection model was generated by fine-tuning a first instance of the pre-trained object detection model, and
the checkbox object detection model was generated by fine-tuning a second instance of the pre-trained object detection model.

15. The entity extraction system of claim 13, wherein:
the text object detection model was generated by fine-tuning a first instance of the pre-trained object detection model,
the signature object detection model was generated by fine-tuning a second instance of the pre-trained object detection model, and
the checkbox object detection model was generated by fine-tuning a third instance of the pre-trained object detection model.

16. The entity extraction system of claim 11, wherein each of the plurality of regions of interest is a region of a corresponding document image among the plurality of document images, and
wherein processing the plurality of document images to detect the plurality of regions of interest includes indicating, for each of the plurality of regions of interest:
a bounding box that indicates a boundary of the region of interest within the corresponding document image, and
a class label that indicates a class of the region of interest, and
wherein:
for at least some of the plurality of text objects, the class of the text object is a first class, and
for each of the plurality of non-text objects, the class of the non-text object is different than the first class.

17. The entity extraction system of claim 11, wherein each of the plurality of regions of interest is a region of a corresponding document image among the plurality of document images, and
wherein, for each of the plurality of regions of interest, producing the corresponding text string is based on a class of the region of interest and on a bounding box that indicates a boundary of the region of interest within the corresponding document image, and
wherein:
for at least some of the plurality of text objects, the class of the text object is a first class, and
for each of the plurality of non-text objects, the class of the non-text object is different than the first class.

18. The entity extraction system of claim 11, wherein:
each of the plurality of regions of interest is a region of a corresponding document image among the plurality of document images;
for each of the plurality of text objects, producing the corresponding text string includes obtaining the text string from the text object, and
for each of the plurality of non-text objects, producing the corresponding text string includes obtaining the text string from a neighbor region of the non-text object within the corresponding document image, wherein a shape of the neighbor region relative to the non-text object is based on a class of the non-text object.

19. The entity extraction system of claim 11, wherein processing the plurality of text strings includes, for each of the plurality of non-text objects:
selecting, based on a class of the non-text object, a dictionary from among a plurality of dictionaries; and
identifying, based on the corresponding text string and the dictionary, an entity associated with the non-text object.

20. One or more non-transitory computer-readable media storing computer-executable instructions to cause a computer to perform the computer-implemented method of claim 1.
